(19) United States
(12) Patent Application Publication
(10) Pub. No.: US 2005/0119046 A1
(43) Pub. Date: Jun. 2, 2005

(54) Game system and gaming management method

(75) Inventor: Jun Fujimoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ARUZE CORP., Tokyo (JP)

(21) Appl. No.: 10/974,816

(22) Filed: Oct. 28, 2004

(30) Foreign Application Priority Data
Oct. 28, 2003 (JP) 2003-367699
Dec. 25, 2003 (JP) 2003-431047

(51) Int. Cl. G06F 17/00

(52) U.S. Cl. 463/25

(57) ABSTRACT

A game system includes: a plurality of gaming machines; and a server. The server includes: an award determination unit that determines, based on sales information of the gaming machines in a first predetermined time period, an award of an amount of the game medium to be paid out from the gaming machines in a second predetermined time period that is later than the first predetermined time period; a payout determination unit that determines a selected gaming machine out of the gaming machines for paying out the award. Each of the gaming machines includes: an information receiving unit that receives information concerning the award and the selected gaming machine from the server, and a gaming media payout unit that pays out the amount of the game medium corresponding to the award at a predetermined timing when the gaming machine corresponds to the selected gaming machine.

### CROSS-REFERENCE TO THE RELATED APPLICATION(S)

This application is based upon and claims a priority from prior Japanese Patent Application No. 2003-367699 filed on Oct. 28, 2003 and from prior Japanese Patent Application No. 2003-431047 filed on Dec. 25, 2003, the entire contents of which are incorporated herein by reference. This application is related to co-pending U.S. application claiming priorities on JP-2003-368452 and JP-2003-431048. The co-pending application is expressly incorporated herein by reference.

### BACKGROUND OF THE INVENTION

1. Field of the Invention

This invention relates to a game system including gaming machines each for a player to play a game using game medium (game value) and a gaming management method and in particular to a game system and a gaming management method for managing the payout amount of game medium based on the sales in each gaming machine.

2. Description of the Related Art

In a conventional game arcade where gaming machines such as slot machines (a so-called Pachinko machines) and slot machines are installed, a player can play a game by inputting game medium such as balls, medals, or cash into a gaming machine. Each gaming machine pays out game medium to the player in response to the winning state (game result) occurring with the progress of the game.

Hitherto, in a casino where slot machines are installed, “jackpot” has been made available to players in such a manner that a part of credit consumed in each slot machine is reserved and when the reservation amount reaches a certain amount, a large amount of payout as impossible with a usual win is conducted from a certain slot machine. (For example, refer to JP-A-2003-117053.) In such slot machines, usually a win occurs at a setup probability and the player advances a game with the expectation that a win will occur. Winning the jackpot will occur in any slot machine at a certain timing by lottery different from normal lottery based on the probability set in each slot machine. To make large the payout amount when a player wins the jackpot, generally a plurality of casinos are connected through a network.

### SUMMARY OF THE INVENTION

However, it is difficult to connect the casinos through a network in a region where the network backbone is not developed. Of course, a configuration wherein casinos are not connected to a network is also possible; however, a considerable time is required until the reservation amount reaches a certain amount, and generally the scale of the payout amount also becomes small.

It is therefore an object of the invention to provide a game system and a gaming management method for sufficiently providing the payout amount of game medium from each gaming machine in a short time even if game arcades are not connected through a network.

According to a first aspect of the invention, there is provided a game system including: a plurality of gaming machines, each of which provides a game to a player and pays out an amount of game medium in accordance with a result of the game; and a server that is connected to the gaming machines and communicates therewith, the server including: an award determination unit that determines, based on sales information of the gaming machines in a first predetermined time period, an award of the amount of the game medium to be paid out from the gaming machines in a second predetermined time period that is later than the first predetermined time period; a payout determination unit that determines a selected gaming machine out of the gaming machines for paying out the award, and wherein each of the gaming machines includes: an information receiving unit that receives information concerning the award and the selected gaming machine from the server, and a gaming media payout unit that pays out the amount of the game medium corresponding to the award at a predetermined timing when the gaming machine corresponds to the selected gaming machine.

According to a second aspect of the invention, there is provided a gaming management method for managing games in a plurality of gaming machines, each of which provides a game to a player and pays out an amount of game medium in accordance with a result of the game, the method including: determining, based on sales information of the gaming machines in a first predetermined time period, an award of the amount of the game medium to be paid out from the gaming machines in a second predetermined time period that is later than the first predetermined time period; determining a selected gaming machine out of the gaming machines for paying out the award; and paying out the amount of the game medium corresponding to the award at a predetermined timing from the selected gaming machine.

### BRIEF DESCRIPTION OF THE DRAWINGS

These and other objects and advantages of the present invention will be more fully apparent from the following detailed description taken in conjunction with the accompanying drawings, in which:

FIG. 1 is a conceptual drawing of a game system according to one embodiment of the invention;

FIG. 2 is a perspective view of a slot machine as an example of a gaming machine forming a part of the game system;

FIG. 3 is a block diagram of a control circuit of the slot machine shown in FIG. 2;

FIG. 4 is a drawing to conceptually show the basic functions of the gaming machine 1 and a server;

FIG. 5 is a sequence diagram to show an example of the operation mode of the gaming machine and the server;

FIG. 6 is a flowchart to show an example of the operation mode of the gaming machine and the server;

FIG. 7 is a drawing to conceptually show the basic functions of a gaming machine according to a modification;

FIG. 8 is a flowchart to show an example of the operation mode of the gaming machine according to the modification shown in FIG. 7;

FIG. 9 is a schematic drawing of the configuration of a game system including public lottery machines as gaming machines;

FIG. 10 is a detailed drawing of the game system in FIG. 9; and

FIG. 11 is an award table to show one mode of award.

### DETAILED DESCRIPTION OF THE PREFERRED EMBODIMENTS

Referring now to the accompanying drawings, there is shown preferred embodiments of the invention.

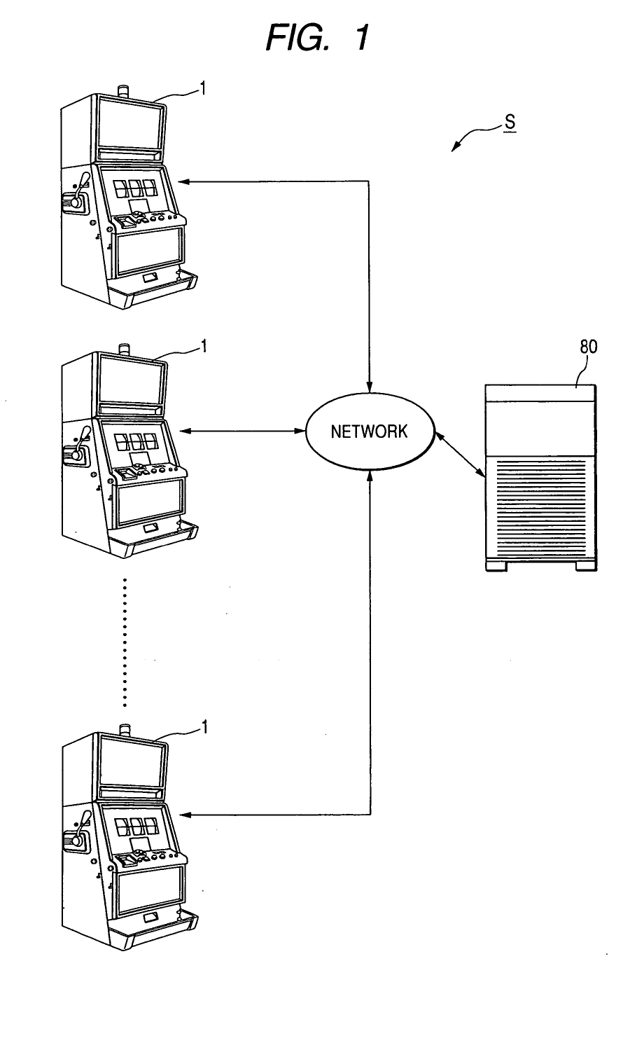

FIG. 1 schematically shows the general configuration of a game system S according to a first embodiment of the invention. As shown in the figure, the game system S includes a plurality of gaming machines 1 and a server 80 connected to the gaming machines 1 through predetermined communication line (for example, a network). The game system S may be adopted in one game arcade where players can play various games, such as a bar or a casino, or may be shared between game arcades. The communication line may be arbitrary if the communication line enables information to be transmitted and received between the gaming machine 1 and the server 80 regardless of radio, a leased circuit, or a switched line.

The gaming machine 1 may be a gaming machine for enabling the player to know the result in real time (single gaming machine) or may be a gaming machine requiring a predetermined time until the result is produced, such as a horse race game, a bingo game, or a public lottery (mass gaming machine). The gaming machines 1 include not only a gaming machine such as a pinball machine or a slot machine where a player plays a game using game medium such as balls or medals and as many game medium as the number in accordance with the game result are paid out to the player, but also a terminal implemented as a personal computer if a player plays a network game using a terminal implemented as a personal computer. The game medium to be used include not only balls or medals, but also payment in cash (coins, bills), electronic money or payment with a credit card or a prepaid card.

On the other hand, the server 80 is a server for managing the gaming machines 1 and is a wide concept including a hall server installed in a game arcade (hall) having the gaming machines 1, a server for collectively managing the gaming machines 1 in each game arcade through the network provided by communication lines or private lines, etc. Each of the gaming machines 1 are assigned with unique identification numbers, and the server 80 determines the source of data sent from each gaming machine 1 based on the identification number. To transmit data from the server 80 to each gaming machine 1, the identification number is also used to specify the transmission destination.

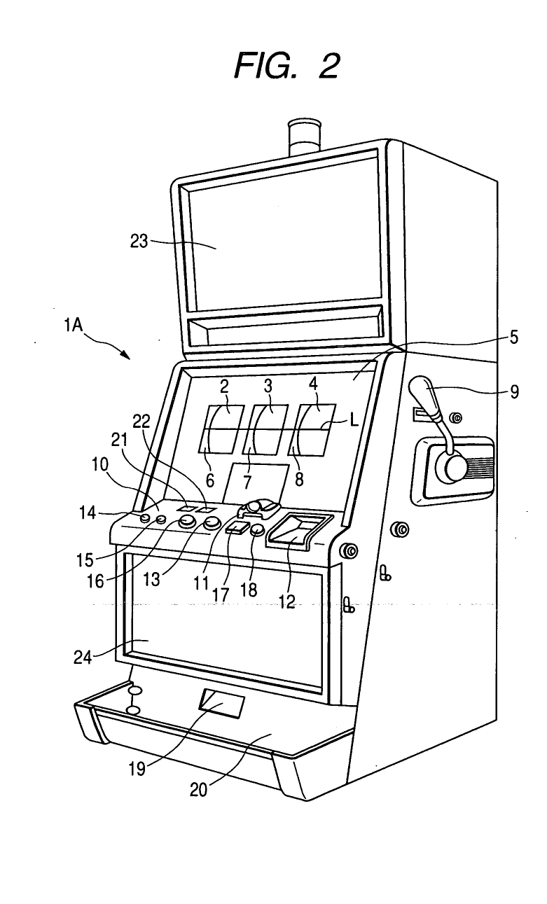

FIG. 2 shows a slot machine as an example of the gaming machine 1. As shown in the figure, three reels of a first reel 2, a second reel 3, and a third reel 4 are provided for rotation in a cabinet in the center of the main body of a slot machine 1A as a gaming machine. Symbol columns including different types of symbols are drawn on the outer peripheral surface of each of the reels 2 to 4. The symbols are variably displayed as a player operates a handle 9 provided on a side of the cabinet in a usual gaming state in which the player inputs a game medal as a game medium and plays a game. A reel display window section 5 is placed on the fronts of the reels 2 to 4. Three symbols drawn on the outer peripheral surface of each of the reels 2 to 4 are displayed through a display window 6, 7, 8 formed in the reel display window section 5. The reel display window section 5 is formed with a pay line L defining a symbol combination, and a combination is determined by the still symbol combination displayed on the pay line L in the display windows 6 to 8. The reel display window section 5 is made of a transparent liquid crystal panel 5d for displaying various pieces of game information and various game effect images while the player plays a game.

A control panel 10 placed below the reel display window section 5 is provided with a medal insertion slot 11 for a player to input a medal and a bill insertion slot 12 for a player to insert a bill. The control panel 10 is also provided with a spin switch 13 for starting rotation of the reels 2 to 4 by pushbutton operation aside from operation of the handle 9 and is further provided with a change switch 14, a cash out switch 15, a bet 1 switch 16, a max bet switch 17, and a stop button 18.

The change switch 14 switches between paying out the medal gained by the player to a medal tray 20 through a payout opening 19 and reserving the medal in the machine as credit. The number of medals in credit in the machine is displayed on a number-of-reserved-medals display section 21 including seven-segment LEDs (light emitting diodes). As the player pushes the cash out switch 15, the medals in credit are paid out to the medal tray 20. As the player presses the bet 1 switch 16 once, only one of the medals in credit is bet on a game. As the player presses the max bet switch 17 once, as many medals as the maximum number that can be bet on one game are bet on the game. The stop button 18 forms stop command acceptance means for accepting from the player a stop command of the symbol row variably displayed on the liquid crystal panel 5d in a free game. The number of medals paid out from the payout opening 19 when a predetermined combination becomes complete on the pay line L is displayed on a number-of-pay-out-medals display section 22.

A pay table indicating how many medals are paid out for a winning game is displayed on top glass 23 above the reel display window section 5. An image of a character of the gaming machine or the like is drawn on bottom glass 24 below the reel display window section 5.

Next, control means for controlling the progress of a game in the slot machine 1A will be discussed.

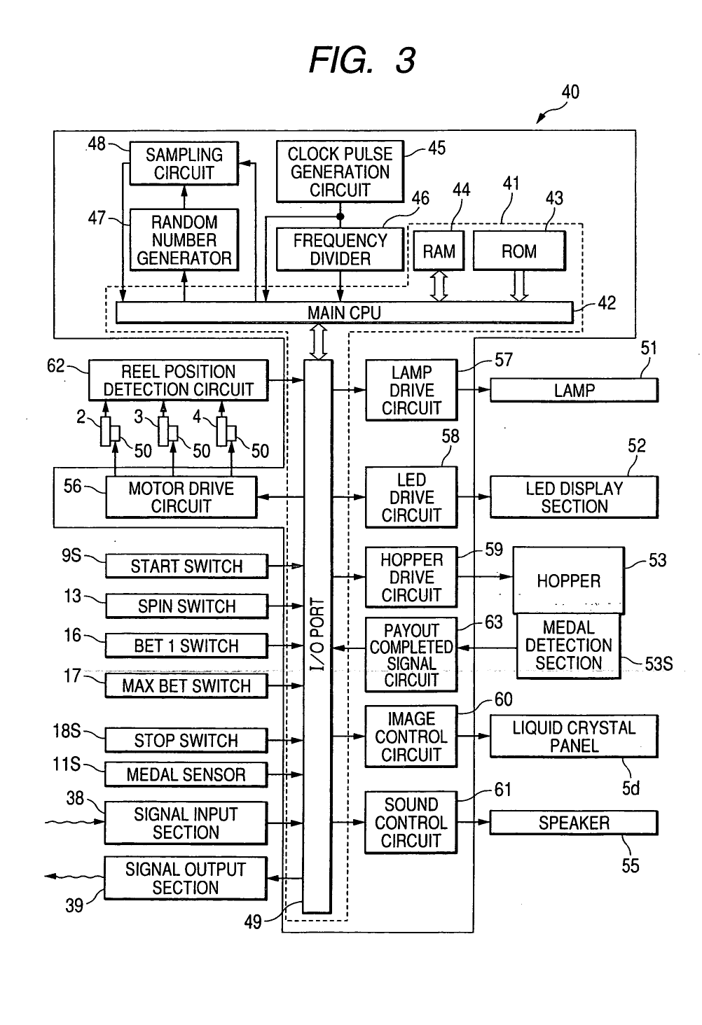

FIG. 3 is a block diagram to show the circuit configuration of a control circuit 40 for controlling the game processing operation of the slot machine 1A. As shown in the figure, the control circuit 40 has a microcomputer 41 as a main component, and the microcomputer 41 is including a main CPU (central processing unit) 42 for performing control operation in accordance with a preset program and ROM (read-only memory) 43 and RAM (random access memory) 44 as storage unit. The ROM 43 stores the whole control processing procedure of the gaming machine as a sequence program, and the RAM 44 is used as a temporary storage work area when the program is executed.

Connected to the main CPU 42 are a clock pulse generation circuit 45 and a frequency divider 46 for generating a reference clock pulse, a random number generator 47 for generating a constant range of random numbers, and a sampling circuit 48 for determining one of the generated random numbers. Further, an I/O port 49 for transferring a signal to and from peripheral devices (actuators) described later is connected to the main CPU 42. In the ROM 43, the storage section is divided so as to store a combination table, a variation mode table, etc., in addition to the sequence program.

The microcomputer 41, the random number generator 47, and the sampling circuit 48 serve as a lottery unit for determining a combination by lottery; the still symbols to be displayed on the display windows 6 to 8 or the liquid crystal panel 5d are selected by lottery and a combination is determined by the selected symbol combination.

The main actuators whose operation is controlled by a control signal from the microcomputer 41 include stepping motors 50 for rotating the reels 2 to 4, various lamps 51, an LED display section 52 of the number-of-reserved-medals display section 21, the number-of-pay-out-medals display section 22, etc., a hopper 53 for storing medals, the liquid crystal panel 5d, and a speaker 55, which are driven or controlled by a motor drive circuit 56, a lamp drive circuit 57, an LED drive circuit 58, a hopper drive circuit 59, an image control circuit 60, and a sound control circuit 61 respectively. The drive circuits 56 to 59 and the control circuits 60 and 61 are connected to an output section of the main CPU 42 via the I/O port 49. The microcomputer 41 and the image control circuit 60 serve as stop control unit for defining the variation mode until the symbols selected by the lottery unit become complete on the pay line L in response to the spacing between the position of each symbol on the pay line L at the acceptance timing of the stop command operation with the stop button 18 and the position of each symbol in accordance with the combination determined by the lottery unit on the display of the liquid crystal panel 5d in a free game. Even if the player operates the stop button 18 at any timing, finally the symbol combination determined by the lottery unit always becomes complete on the pay line L regardless of the operation timing. In the embodiment, a signal output section 39 forming communication line for transmitting a signal to the server 80 is also connected to the output section of the main CPU 42 via the I/O port 49.

Main input signal generation unit for generating input signals required for the microcomputer 41 to generate control signals include: a signal input section 38 forming communication line for receiving a command signal from the server 80; a start switch 9S for detecting operation of the handle 9; the spin switch 13; the bet 1 switch 16; the max bet switch 17; a stop switch 18S for detecting operation of the stop button 18; and a medal sensor 11S for detecting a medal input into the medal insertion slot 11. Further, a reel position detection circuit 62 for detecting the rotation positions of the reels 2 to 4 is included.

Further, the input signal generation unit includes a medal detection section 53S for counting the number of medals paid out from the hopper 53 and a payout completion signal generation circuit 63. The payout completion signal generation circuit 63 generates a signal for detecting completion of the medal payout when the actually paid-out medal count input from the medal detection section 53S reaches the number-of-award-medals data displayed on the number-of-pay-out-medals display section 22. The circuits making up the input signal generation unit are also connected to the main CPU 42 via the I/O port 49.

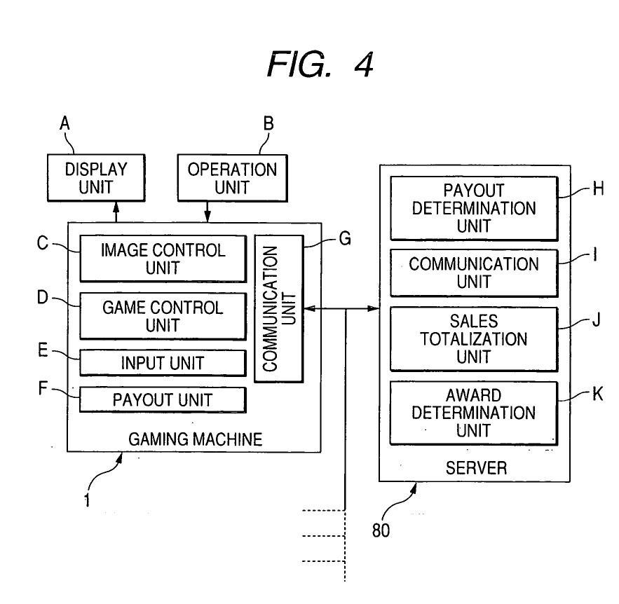

FIG. 4 conceptually shows the basic functions of the gaming machine 1 and the server 80. As shown in the figure, each gaming machine 1 includes display unit A for producing display required for a game, operation unit B for performing operation required for a game, image control unit C for controlling output of a predetermined image displayed on the display unit A, game control unit D for totally controlling the progress of a game, input unit E for inputting a game medium (game value) into the machine, payout unit F for paying out as many game medium as the number in accordance with the game result to the player, and communication unit G for transferring a signal between the gaming machine 1 and the server 80. Taking the slot machine 1A previously described with reference to FIGS. 2 and 3 as an example, the display unit A corresponds to the reel display window section 5, the liquid crystal panel 5d, etc., the operation unit B corresponds to the handle 9, the spin switch 13, the bet 1 switch 16, the max bet switch 17, the stop button 18, etc., the image control unit C corresponds to the image control circuit 60, the game control unit D corresponds to the control circuit 40, the input unit E corresponds to the medal insertion slot 11 and its associated sensor 11S, etc., the payout unit F corresponds to the hopper 53, the change switch 14, and the cash out switch 15, and the communication unit G corresponds to the signal input section 38 and the signal output section 39.

On the other hand, the server 80 includes: a sales totalization unit J for totalizing sales in each gaming machine 1 for a predetermined time period; an award determination unit K for determining the payout amount of game medium in a predetermined time period based on the sales totalized by the sales totalization unit J and distributing the payout amount in a predetermined distribution percentage; a payout determination unit H for determining by lottery the gaming machine 1 for paying out each payout amount (award) of game medium distributed in the predetermined distribution percentage; and a communication unit I for transferring a signal to and from each gaming machine 1. The server 80 has a central processing unit (CPU), main memory (RAM), read-only memory (ROM), an input-output unit (I/O), and external storage such as a hard disk drive. A predetermined program is executed by an information processing apparatus, whereby the means H, I, J, and K making up the server 80 are implemented.

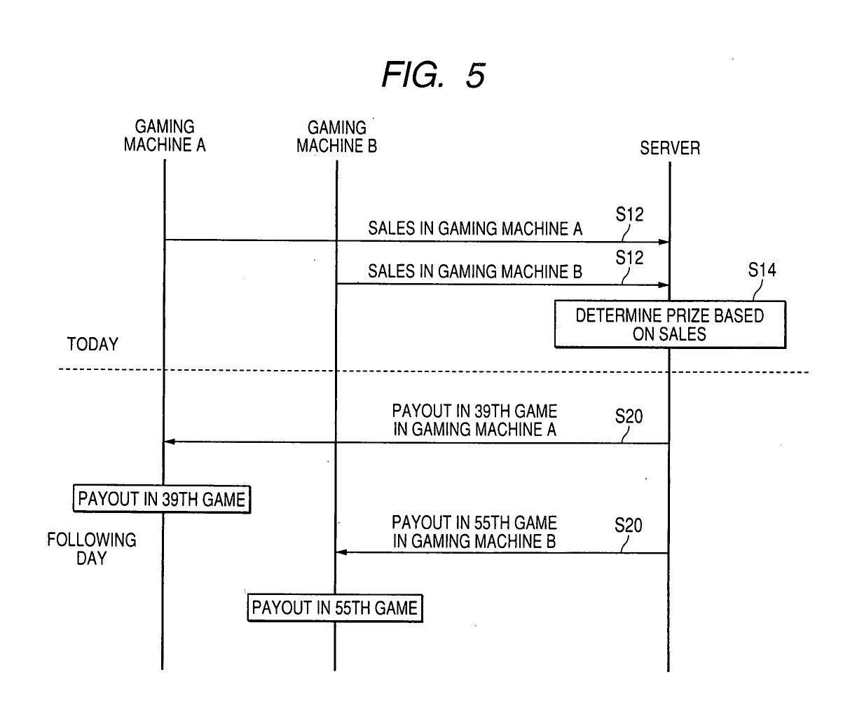

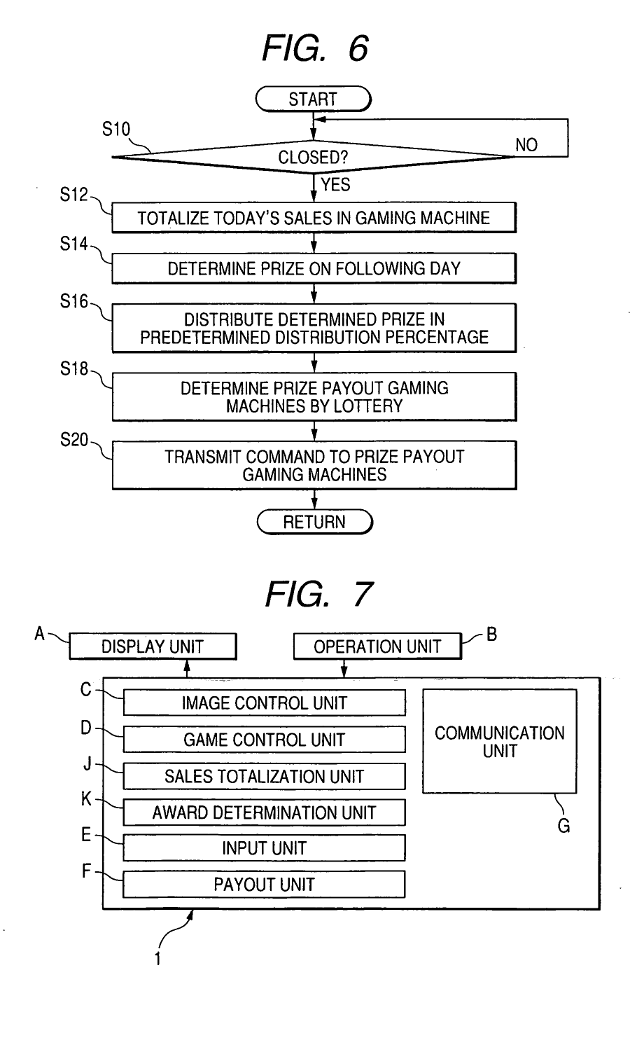

An example of the operation mode of the gaming machine 1 and the server 80 having the functions is shown in a sequence diagram of FIG. 5 and a flowchart of FIG. 6. In this example, a prize system is adopted; after the prize on the day is determined in response to the sales in each gaming machine 1 on the preceding day, the prize is paid out from the gaming machine 1 specified on the day. Taking the slot machine 1A previously described with reference to FIGS. 2 and 3 as an example, the prize corresponds to the number of game medals paid out from the hopper 53 of the slot machine 1A.

First, for example, when the game arcade is closed (S10), the sales in each gaming machine 1 on the day are totalized by the sales totalization unit J of the server 80 (S12). In this case, the sales in each gaming machine 1 required for totalizing the sales are sent from the gaming machines 1 (in FIG. 5, gaming machine A, gaming machine B, . . . ) through the communication unit G and I to the server 80, for example. Taking the slot machine 1A in FIGS. 2 and 3 as an example, information concerning the bet count on the day that can be obtained through the bet switches 16 and 17 is sent from the signal output section 39 to the server 80, whereby the sales in each slot machine 1A on the day can be calculated and totalized by the server 80. In this case, the bet count information may be sent to the server 80 in real time each time the bet switch 16 or 17 is pressed (each time a game is played). However, in the example wherein the prize on the following day is determined by the sales on the preceding day, it is desirable that the bet count information should be transmitted from each slot machine 1A to the server 80 collectively at the end of one day (when the game arcade is closed on the day) from the viewpoint of preventing the communication amount from uselessly increasing.

When the sales in each gaming machine 1 on the day are totalized by the sales totalization unit J, subsequently the amount of the prize on the following day is determined by the award determination unit K based on the sales (S14). In this case, the amount of the prize is the amount resulting from subtracting the profit, etc., from the sales on the day, for example. If the sales on the day are all reflected on the prize on the following day as in the example, the amount of the prize can vary from one day to another. For example, when the sales on Sunday are large, the amount of the prize on Monday is advantageous to the player. To eliminate such inequality, for example, it is also possible to take measures to distribute the average sales a day, etc, in the preceding week to each day in the following weak uniformly.

In the embodiment, the amount of the prize is determined by the award determination unit K after the total sales of the day is calculated by the sales totalization unit J. However, in a game system in which the present invention is applied, there may be configured that amount of money to be used as a part of the prize on the following day is calculated by each of the gaming machines (by subtracting profits from sales in each of the gaming machine) and that each of the gaming machines respectively sends the information indicating the amount of money to the server. In this case, the sales totalization unit J of the server totalizes the amount of money, and the award determination unit K determines the amount of the prize on the following day based on the total amount of money that is totalized by the sales totalization unit J.

As apparent from above, sales information that is transmitted from each of the gaming machines to the server and is used for determining the award of the amount of the prize on the following day, may be arbitrary information that is be used for determining the award.

When the award determination unit K thus determines the amount of the prize on the following day, the award determination unit K further distributes the determined amount of the prize in a predetermined distribution percentage (S16). For example, 50% of the determined amount of the prize is prize A, 30% of the determined amount of the prize is prize B, and 20% of the determined amount of the prize is prize C.

When the prize is thus distributed, subsequently the payout determination unit H determines the gaming machines 1 for paying out the prize A, the prize B, and the prize C by lottery (S18) For example, the gaming machines A, B, . . . are selected as the payout gaming machines from among a number of gaming machines by lottery. The determined information is transmitted through the communication unit I to the gaming machines A, B, . . . as the payout gaming machines as a command signal (S20). The command signal also contains the prize payout timing, for example. That is, according to the command signal, the prize A (or a given amount of game medium having a value corresponding to the prize A) is paid out in the 39th game from the gaming machine A (for example, a win occurs in the 39th game in the gaming machine A and the prize A is paid out therefrom), and the prize B (or a given amount of game medium having a value corresponding to the prize B) is paid out in the 55th game from the gaming machine B. Taking the slot machine 1A in FIGS. 2 and 3 as an example, the command signal is received through the signal input section 38 by the CPU 42, which then sets the reel symbols to a predetermined combination in the game at a predetermined time and supplies a payout command signal to the hopper drive circuit 59 for paying out a predetermined number of medals from the hopper 53.

As described above, in the game system S of the embodiment, based on the sales information in each gaming machine 1 in a predetermined time period, the payout amount of game medium from each gaming machine 1 in a later predetermined time period is determined, so that the payout amount of game medium from each gaming machine 1 can be sufficiently provided in a short time without waiting for the reservation amount to reach a certain amount as with “jackpot” and without connecting the game arcades where a plurality of gaming machines are installed through a network (therefore, for example, even in one game arcade or in a single gaming machine).

The game system S of the embodiment adopts the prize competition system wherein the payout amount determined by the award determination unit K is distributed in a predetermined distribution percentage, thereby determining the payout amount award and the award payout gaming machines 1 are determined and only the determined gaming machines 1 pay out the payout amount of game medium corresponding to the award at a predetermined timing. Thus, the award can be concentrated on the specific gaming machines A, B, . . . and highly interesting amusements of “get rich quick” type like “jackpot” can be provided.

In the embodiment, the server 80 is provided with the sales totalization unit J. However, the sales totalization unit J is not need to be provided in the server 80. For example, a manager of the game arcade may manually totalize the sales in each gaming machine 1 and may determine the prize based on the totalized sales and then may register the sales information in the server 80. It is also considered that the sales in each gaming machine 1 cannot be grasped from the gaming machine 1 because of the nature of the game arcade and the gaming machine 1. For example, there may be the case where a medal exchanger is used to exchange medals for cash. In this case, the sales may be totalized with the medal exchanger. At this time, the total sales in the whole game arcade containing not only the sales in one kind of gaming machine (for example, slot machine 1A), but also the sales in other gaming machines (for example, poker game, etc.,) may be totalized.

The lottery unit installed in the gaming machine 1 may be used for lottery of payout using no prize. In this case, when the command signal is received from the server 80, the command signal is followed. Further, in this case, when duplicate lottery is held in the gaming machine 1, control is performed so as to follow the command signal preferentially. Of course, to simplify or skip such control, preferably the command signal is previously transmitted to the gaming machines 1 before the game arcade is opened. The server 80 may perform all control (lottery processing, etc.,) also containing payout using no prize without providing the gaming machine 1 with the lottery unit.

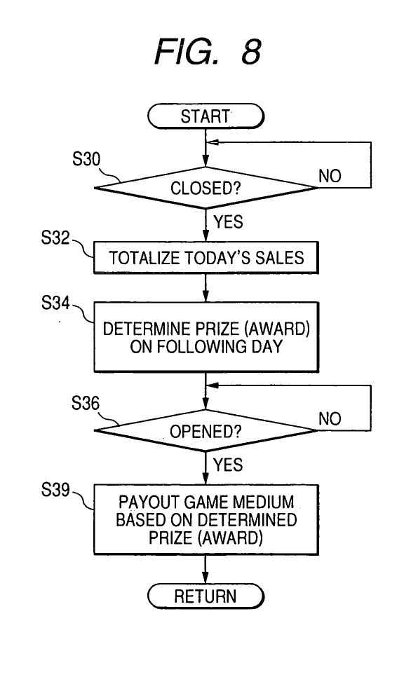

FIGS. 7 and 8 show a modification wherein the gaming machine 1 totalizes the sales therein and determines the prize to be paid out in response to the totalization result without using the server 80. Thus, in the modification, the sales totalization unit J and the award determination unit K are installed in the gaming machine 1 as shown in FIG. 7.

In the modification, first, for example, when the game arcade is closed (S30), the sales in the gaming machine 1 on the day are totalized by the sales totalization unit J of the gaming machine 1 (S32). When the sales in the gaming machine 1 on the day are thus totalized by the sales totalization unit J, subsequently the amount of the prize on the following day is determined by the award determination unit K of the gaming machine 1 based on the sales (S34). At the same time as the game arcade is opened on the following day (S36), the gaming machine 1 pays out game medium based on the prize determined by the gaming machine 1 (S38).

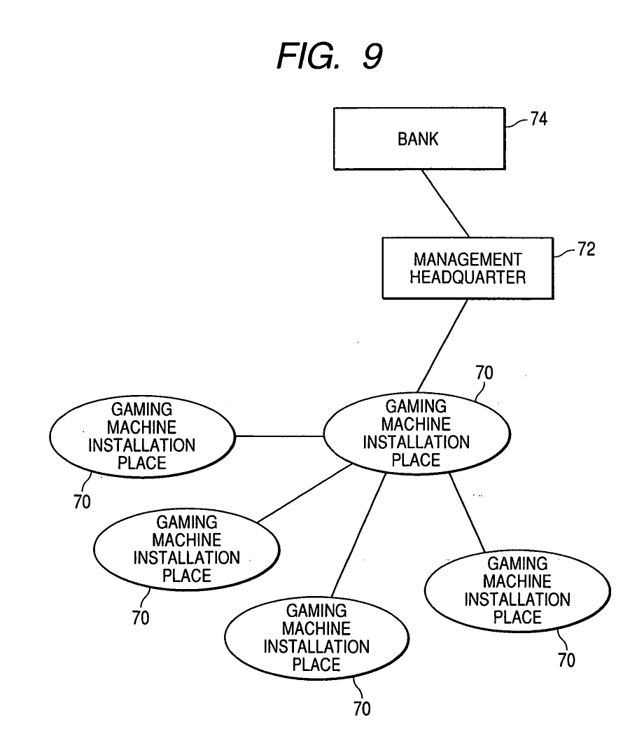

FIGS. 9 to 11 show a second embodiment according to the invention, in which the invention is applied to a public lottery award system. As schematically shown in FIG. 9, the public lottery award system according to the second embodiment includes a plurality of gaming machine installation places 70 where public lottery machines are installed as gaming machines (The gaming machine installation places 70 includes a places such as casinos, hotels, and street corners.), a management headquarter 72, which serves as a server 80 of the first embodiment, for managing the awards of the public lottery, and a bank 74 for converting the awards of the public lottery into cash. The gaming machine installation places 70, the management headquarter 72, and the bank 74 are connected through communication line.

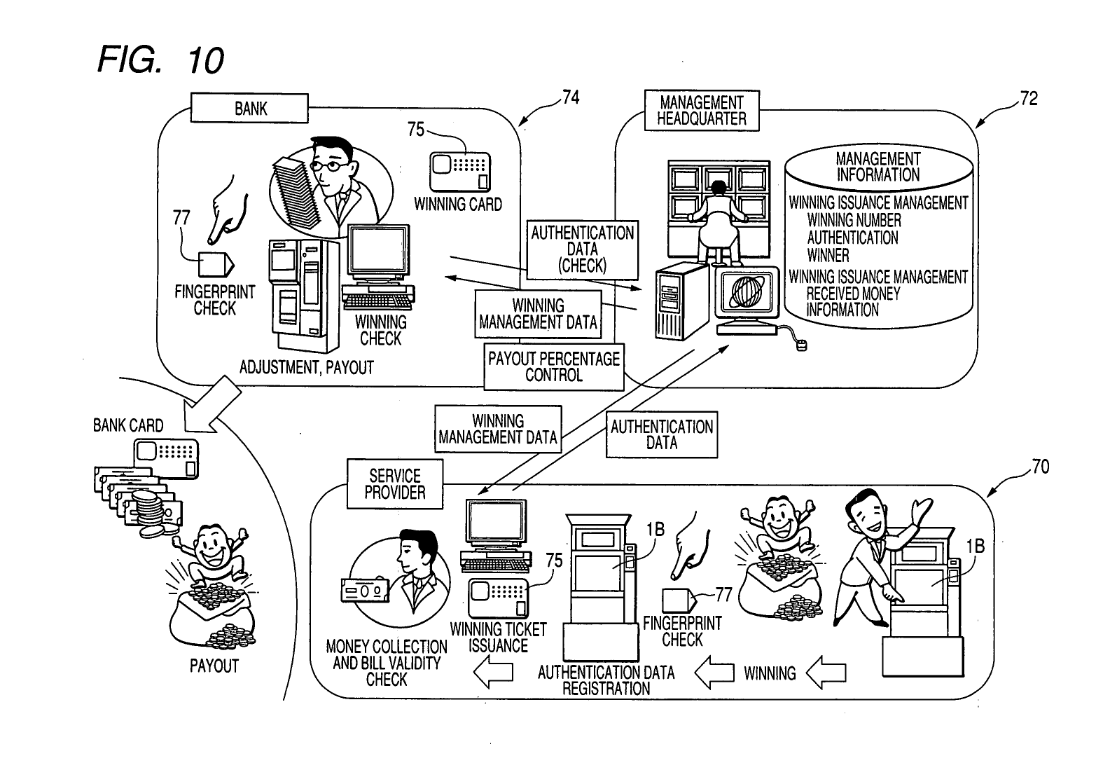

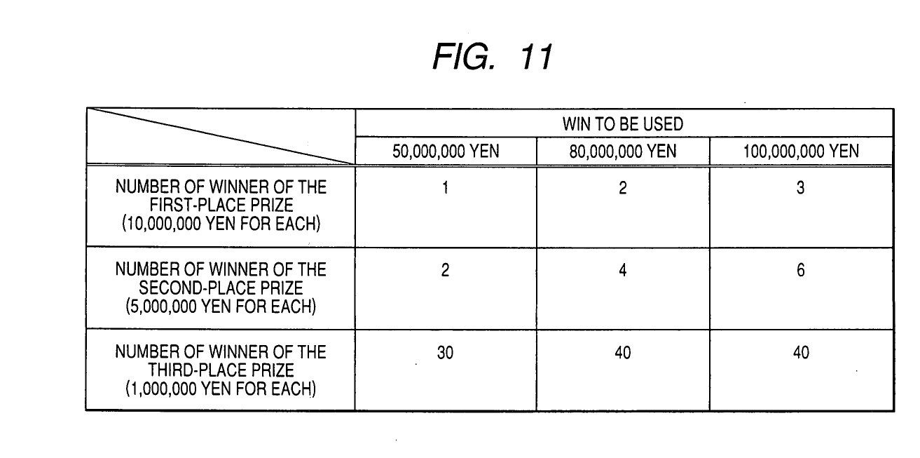

As specifically shown in FIG. 10, at least one public lottery machine (gaming machine) 1B is installed in each gaming machine installation places 70. As a player inputs a game medium such as cash and performs predetermined operation, the public lottery machine 1B gives the winning or losing result of the public lottery to the player then and there. The public lottery machine 1B includes display unit A for producing display required for a game of public lottery, operation unit B for performing operation required for a game of public lottery, image control unit C for controlling output of a predetermined image displayed on the display unit A, game control unit D for totally controlling a game of public lottery, input unit E for inputting game medium such as cash into the machine, payout unit F for paying out a winning lottery ticket (winning ticket) 75 as the award to the player, and communication unit G for transferring a signal to and from the management headquarter 72 as with the case shown in FIG. 4. The public lottery machine 1B also includes an authentication data registration function capable of registering the authentication data of the winner (player to whom a winning lottery ticket 75 is issued).

On the other hand, the management headquarter 72 has a server 80 shown in FIG. 4. That is, the server 80 includes sales totalization unit J for totalizing the sales in each public lottery machine 1B for a predetermined time period, award determination unit K for determining the amount of win (payout amount of award) in a predetermined time period based on the sales totalized by the sales totalization unit J and distributing the win amount in a predetermined distribution percentage, payout determination unit H for determining by lottery the public lottery machine 1B for paying out the win distributed in the predetermined distribution percentage, and communication unit I for transferring a signal to and from each public lottery machine 1B. The server 80 processes various pieces of data required for winning issuance management such as the winning number, the authentication data, and received money information and totally manages each gaming machine installation place 70.

The bank 74 can make winning check using the winning lottery ticket 75 issued by the public lottery machine 1B and can also conduct various types of communications with the management headquarter 72 in such a manner that it inquires about the authentication data in the management headquarter 72, for example, as described later.

Next, an example of a flow of the described public lottery award system will be discussed in detail with reference to FIGS. 5, 6, and 10. Also in the example, a prize competition system is adopted; after the win (prize) on the day is determined in response to the sales in each public lottery machine 1B on the preceding day, the win is paid out from the public lottery machine 1B specified on the day.

To begin with, for example, when the gaming machine installation place 70 is closed (S10 in FIG. 6), the sales in each public lottery machine 1B on the day are totalized by the sales totalization unit J of the server 80 (S12 in FIG. 6). In this case, the sales in each public lottery machine 1B required for totalizing the sales are sent from the public lottery machines 1B (in FIG. 5, gaming machine A, gaming machine B, . . . ) through the communication unit G and I to the server 80, for example. Specifically, the amounts of cash input to each public lottery machine 1B are automatically totalized in the public lottery machine 1B and the totalization result is sent to the server 80. Alternatively, a manager in each gaming machine installation place 70 (or a service provider that installs the gaming machine and collects money from the public lottery machines) collects and totalizes cash from each public lottery machine 1B and reports the totalization result to the management headquarter 72 by any desired method (for example, electronic input). In this case, it is desirable that the collected bills, etc., (cash) should be checked for validity.

When the sales in each public lottery machine 1B on the day are totalized by the sales totalization unit J, subsequently the amount of the win (prize; award payout amount) on the following day is determined by the award determination unit K based on the sales (S14 in FIG. 6). In this case, the amount of the win is the amount resulting from subtracting the profit, etc., (if counterfeit money is contained, the amount of the counterfeit money is also contained) from the sales on the day, for example. Particularly, in the example, 50% of the sales on the day are applied to the win on the following day (payout percentage control is performed). In such payout percentage 50% control, 50% of the total sales handled in the management headquarter 72, namely, the sum total of the sales in all gaming machine installation places 70 managed by the management headquarter 72 may be used as the sum total of the win (prize) on the following day in all gaming machine installation places 70 managed by the management headquarter 72 or 50% of the sales in each gaming machine installation place 70 may be used as the win (prize) on the following day in the gaming machine installation place 70. In the former, the total sales are used and thus the number of winning tickets (win amount) can be increased and winnings are not necessarily concentrated on the gaming machine installation place 70 with large sales. On the other hand, in the latter, the sales in each gaming machine installation place 70 are reflected on the win in the gaming machine installation place 70 as they area, and therefore the latter is excellent in equitability.

When the award determination unit K thus determines the amount of the win on the following day, the award determination unit K further distributes the determined amount of the win (prize) in a predetermined distribution percentage (S16 in FIG. 6). For example, as shown in FIG. 11, the award determination unit K distributes the win as follows that: in a case where 50,000,000 yen can be used as the win on the following day based on the sales on the day, the award determination unit K distributes the win in such a manner that one ticket is given as the first-place prize of 10,000,000 yen, two tickets are given as the second-place prize of 5,000,000 yen, and 30 tickets are given as the third-place prize of 1,000,000 yen; in a case where 80,000,000 yen can be used as the win, the award determination unit K distributes the win in such a manner that two ticket is given as the first-place prize of 10,000,000 yen, four tickets are given as the second-place prize of 5,000,000 yen, and 40 tickets are given as the third-place prize of 1,000,000 yen; and in a case where 100,000,000 yen can be used as the win, the award determination unit K distributes the win in such a manner that three ticket is given as the first-place prize of 10,000,000 yen, six tickets are given as the second-place prize of 5,000,000 yen, and 40 tickets are given as the third-place prize of 1,000,000 yen. At this time, it is desirable that the amount of the first-place prize should be kept the same regardless of the win amount determined by the award determination unit K (the amount that can be used as the win on the following day). Accordingly, expectation at a predetermined level or more can always be given to the player and highly interesting amusements can be maintained.

When the win is thus distributed, subsequently the payout determination unit H determines the public lottery machine 1B for paying out the distributed win (prize) by lottery (S18 in FIG. 6). For example, in the payout percentage 50% control in which 50% of the total sales in all gaming machine installation places 70 are used as the sum total of the win on the following day, the payout determination unit H determines the machine for paying out the win by lottery from among any public lottery machines 1B installed in any gaming machine installation place 70. On the other hand, in the payout percentage 50% control in which 50% of the sales in each gaming machine installation place 70 are used as the win on the following day in the gaming machine installation place 70, the payout determination unit H determines the machine for paying out the win by lottery individually in each gaming machine installation place 70. The determined information is transmitted as a command signal through the communication unit I to the public lottery machine 1B as the machine for paying out the win (S20 in FIG. 6). The command signal may contain the timing at which the win will be paid out, for example.

After the information concerning the determination of the machine for paying out the win is distributed as described above, a game (public lottery game) is restarted in each gaming machine installation place 70 on the following day. That is, a player inputs a game medium such as cash into a predetermined public lottery machine 1B and performs predetermined operation (or plays a game). If the player wins a prize in the public lottery, a winning lottery ticket 75 is issued from the public lottery machine 1B. As the thicket is issued, the player conducts authentication data registration as required. In the authentication data registration, for example, the player registers his or her fingerprint and a record card 77 on which the registration data is recorded is issued. The data concerning issuance of the winning lottery ticket 75 and the authentication data are sent through the communication unit G to the management headquarter 72. Later, the player can bring the winning lottery ticket 75 and the record card 77 to the bank 74 to receive the win in cash. In this case, the bank 74 sends an electronic inquiry to the management headquarter 72 through the communication line for checking the winning using the winning lottery ticket 75 and checking the authentication data for validity using the record card 77. That is, for example, the authentication data is transmitted to the management headquarter 72 and winning management data is received from the management headquarter 72, whereby whether or not the winning is true is checked and the person who is going to receive the win is the true winner is checked.

In the described configuration, the machine for paying out the win is determined by lottery in the management headquarter 72 and the determination information is transmitted to the gaming machine installation place 70 as a command signal, but the management headquarter 72 may determine only award distribution of the win (the number of winning tickets) as shown in FIG. 11, and the machine for paying out the win is determined by lottery in the gaming machine installation place 70. To realize the lottery in the gaming machine installation place 70, a server for managing the public lottery machine 1B may be provided in the gaming machine installation place 70. Such a server separately installed in the gaming machine installation place 70 may serve as an apparatus for lightening the processing load of the management headquarter 72.

In the described configuration, if the machine for paying out the win is determined, the case where the number of games to pay out the win is not complete in the public lottery machine 1B (for example, if it is determined that the win will be paid out at the 30th game, the case where the number of public lottery games played by player does not reach 30) is also possible. In this case, the win may be carried over to the following day. For example, if one thick of the first-place prize (10,000,000 yen) is not paid out, the number of the first-place prize tickets on the following day may be incremented by one. In the described configuration, each public lottery machine 1B may include the configuration and the functions in FIGS. 7 and 8.

In the described configuration, the means for converting the awards of the public lottery into cash has been described by taking the bank as an example, but an adjustment office contiguous with each gaming machine installation place, an ATM, etc., can also be named as the means (place) for converting the awards of the public lottery into cash.

As described above, according to the embodiments, based on the sales information in each gaming machine in a predetermined time period, the payout amount of game medium from each gaming machine in a later predetermined time period is determined, so that the payout amount of game medium from each gaming machine can be sufficiently provided in a short time without waiting for the reservation amount to reach a certain amount as with “jackpot” and without connecting the game arcades where a plurality of gaming machines are installed through a network (therefore, for example, even in one game arcade or in a single gaming machine)

In the embodiments, the prize system is adopted wherein the award is determined by the award determination unit and the gaming machines to pay out the award are determined and only the determined gaming machines pay out the payout amount of game medium corresponding to the award at a predetermined timing. Thus, the award can be concentrated on the specific gaming machines and highly interesting amusements of “get rich quick” type like “jackpot” can be provided. In this case, the award determination unit may determine the award by distributing the payout amount determined based on the sales information in the gaming machine in a predetermined distribution percentage. Accordingly, the award can also be shared among several gaming machines to increase opportunities to obtain award.

In the embodiments, “the sales information in each gaming machine in a predetermined time period” may be transmitted from the gaming machine directly to the server or after the sales in each gaming machine are totalized by any other means than the gaming machine, the sales information may be input to the server. To transmit “the sales information in each gaming machine in a predetermined time period” from the gaming machine directly to the server, it is desirable that the server should include sales totalization unit for totalizing sales in each gaming machine in a predetermined time period.

According to the embodiments, based on the sales information in each gaming machine in a predetermined time period, the payout amount of game medium from each gaming machine in a later predetermined time period is determined, so that the payout amount of game medium from each gaming machine can be sufficiently provided in a short time without waiting for the reservation amount to reach a certain amount as with “jackpot” and without connecting the game arcades where a plurality of gaming machines are installed through a network, and the award can be concentrated on the specific gaming machines and highly interesting amusements of “get rich quick” type like “jackpot” can be provided.

According to the embodiments, even if the game arcades are not connected through a network, the payout amount of game medium from each gaming machine can be sufficiently provided in a short time.

Although the embodiments of the invention have been described, it is to be understood that the invention is not limited to the specific embodiment thereof and various modifications and changes may be made without departing from the spirit and the scope of the invention.

The invention can be applied to a game system including various gaming machines such as slot machines (Pachinko machines) in addition to the slot machines and public lottery award systems as described in the embodiments.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A game system comprising:
a plurality of gaming machines, each of which provides a game to a player and pays out an amount of game medium in accordance with a result of the game; and
a server that is connected to the gaming machines and communicates therewith, the server including:
an award determination unit that determines, based on sales information of the gaming machines in a first predetermined time period, an award of an amount of the game medium to be paid out from the gaming machines in a second predetermined time period that is later than the first predetermined time period;
a payout determination unit that determines a selected gaming machine out of the gaming machines for paying out the award, and
wherein each of the gaming machines includes:
an information receiving unit that receives information concerning the award and the selected gaming machine from the server, and
a gaming media payout unit that pays out the amount of the game medium corresponding to the award at a predetermined timing when the gaming machine corresponds to the selected gaming machine.

2. The game system according to claim 1, wherein the award determination unit determines the award by distributing the amount of the game medium to be paid out to a plurality of pieces at a predetermined distribution percentage, and
wherein the payout determination unit determines a plurality of selected gaming machines out of the gaming machines for paying out the award.

3. The game system according to claim 1, wherein the server further includes a sales totalization unit that totalizes sales in each of the gaming machine in the first predetermined time period, and
wherein the award determination unit determines the award based on the sales totalized by the sales totalization unit.

4. The game system according to claim 1, wherein the gaming media payout unit pays out a winning ticket exchangeable with the amount of the game medium corresponding to the award.

5. A gaming management method for managing games in a plurality of gaming machines, each of which provides a game to a player and pays out an amount of game medium in accordance with a result of the game, the method comprising:
determining, based on sales information of the gaming machines in a first predetermined time period, an award of an amount of the game medium to be paid out from the gaming machines in a second predetermined time period that is later than the first predetermined time period;
determining a selected gaming machine out of the gaming machines for paying out the award; and
paying out the amount of the game medium corresponding to the award at a predetermined timing from the selected gaming machine.

6. The gaming management method according to claim 5, wherein the award is determined by distributing the amount of the game medium to be paid out to a plurality of pieces in a predetermined distribution percentage.

7. The gaming management method according to claim 5, wherein the amount of the game medium corresponding to the award is paid out as a winning ticket exchangeable therewith.
